(19) United States
(12) Patent Application Publication
(10) Pub. No.: US 2025/0102225 A1
(43) Pub. Date: Mar. 27, 2025

(54) FILTER-DRYING DEVICE AND METHOD FOR FILTER-DRYING BY MEANS OF SUCH A FILTER-DRYING DEVICE

(71) Applicant: VETTER PHARMA-FERTIGUNG GMBH & CO. KG, Ravensburg (DE)

(72) Inventors: Michael WOLFF, Gestratz (DE); Lukas KROPP, Baienfurt (DE)

(21) Appl. No.: 18/727,939

(22) PCT Filed: Jan. 19, 2023
(86) PCT No.: PCT/EP2023/051288

§ 371 Date: Jul. 10, 2024

(30) Foreign Application Priority Data
Jan. 21, 2022 (DE) 10 2022 101 476.2

(51) Int. Cl. F26B 21/00; B01D 46/42; F26B 21/10

(52) U.S. Cl. CPC F26B 21/006; B01D 46/42; F26B 21/10; B01D 2273/18; B01D 2279/35

(57) ABSTRACT

A filter-drying device having a compressed-air connector and at least one filter connector, wherein the filter-drying device is adapted to fluidically connect the compressed-air connector to the at least one filter connector in a first functional state and to fluidically separate it from the at least one filter connector in a second functional state, wherein the at least one filter connection is adapted to receive a filter, in particular a multi-usable ventilating filter, and to form an airtight connection between the filter-drying device and the filter.

### CROSS-REFERENCE TO RELATED APPLICATIONS

This application is a U.S. National Phase Application under 35 U.S.C. 371 of International Application No. PCT/EP2023/051288, filed on Jan. 19, 2023, which claims the benefit of German Patent Application No. 10 2022 101 476.2, filed on Jan. 21, 2022. The entire disclosures of the above patent applications are incorporated herein by reference.

### FIELD

The invention relates to a filter-drying device and a process for filter-drying by means of such a filter-drying device.

### BACKGROUND

This section provides background information related to the present disclosure which is not necessarily prior art.

It is known that filters, in particular multi-usable filters, in particular multi-usable hydrophobic media filters, are subjected to a filter test by means of a media providing filter test device, in particular by means of an AquaWIT device from the company PALL, in order to verify an integrity of the filter. During the filter test, in particular a so-called water intrusion test (WIT), the filter is in particular completely filled with water in order to create a water column in the filter. The water column is then applied with a predetermined pressure and a water evaporation flow through a filter membrane is determined. If a predetermined water evaporation flow assigned to a membrane is exceeded, the integrity of the filter cannot be guaranteed. Following such a filter test, it is necessary to dry the filters, particularly from the inside.

This filter-drying is carried out either in a drying cabinet or by means of an autoclave. A disadvantage of a drying of the filters in a drying cabinet is that the drying is very time-consuming, in particular taking longer than eight hours, and that the filter is exposed to thermal stress in the drying cabinet, whereby the filter can be irreparably damaged. A disadvantageous of a drying of the filters by means of an autoclave is that drying is also very time-consuming and that a complete drying of the filters cannot be guaranteed.

### SUMMARY

This section provides a general summary of the disclosure, and is not a comprehensive disclosure of its full scope or all of its features.

The underlying problem of the invention is therefore to create a filter-drying device and a process for filter-drying by means of such a filter-drying device, wherein the aforementioned disadvantages are at least partially eliminated, preferably avoided.

The problem is solved by providing the present technical teaching, in particular the teaching of the independent claims and the embodiments disclosed in the dependent claims and the description.

In particular, the problem is solved by providing a filter-drying device having a compressed-air connector and at least one filter connector. The filter-drying device is adapted to fluidically connect the compressed-air connector to the at least one filter connector in a first functional state and to fluidically separate it from the at least one filter connector in a second functional state. The at least one filter connector is adapted to receive a filter and to form an airtight connection between the filter-drying device and the filter.

Advantageously, by means of such a filter-drying device, it is possible in a simple manner to dry the filter connected to the at least one filter connector by means of compressed air directed through the filter by the filter-drying device.

The filter-drying device makes it possible to dry a filter quickly and completely by means of compressed air, in particular without subjecting the filter to thermal stress whereby the functionality of the filter may be impaired.

Preferably, the at least one filter connector of the filter-drying device is adapted to receive a multi-usable hydrophobic media filter for compressed air and vapour, in particular a multi-usable ventilating filter, and to form an airtight connection between the filter-drying device and the multi-usable hydrophobic media filter for compressed air and vapour, in particular the multi-usable ventilating filter. Alternatively or additionally, the at least one filter connector of the filter-drying device is preferably adapted to receive a filter of the company PALL, in particular of the type NOVASIP C3PFRPIA, in the embodiment obtainable on the day identifying the seniority of the present intellectual property right, and to form an airtight connection between the filter-drying device and such a filter. Alternatively or additionally, the at least one filter connector is preferably adapted to receive a filter having a connector, in particular a TC connector, in accordance with DIN 32676:2009-05 in the version obtainable on the day identifying the seniority of the present intellectual property right and to form an airtight connection between the filter-drying device and such a filter.

In a preferred embodiment, the compressed-air connector is configured as a connector for sterile compressed air, in particular as a sterile air connector.

According to a further development of the invention, it is provided that the filter-drying device has a pressure control device. The pressure control device is fluidically connected to the compressed-air connector and the filter connector and fluidically arranged between the compressed-air connector and the filter connector.

Advantageously, it is thus possible to control and regulate the pressure of the compressed air directed through the filter-drying device, in particular to measure and/or adjust it, in particular to control or regulate it.

In particular, the pressure control device is adapted to adjust, in particular to control or regulate, the pressure of the compressed air above a first predetermined pressure limit value, wherein the first predetermined pressure limit value is preferably 1.2 bar. Alternatively or additionally, the pressure control device is in particular adapted to adjust, in particular to control or regulate, the pressure of the compressed air below a second predetermined pressure limit value, wherein the second predetermined pressure limit value is preferably 1.8 bar. Alternatively or additionally, the pressure control device is in particular adapted to adjust, in particular to control or regulate, the pressure of the compressed air to a target pressure, wherein the target pressure is preferably from 1.2 bar to 1.8 bar, preferably 1.6 bar, and/or wherein the target pressure is matched to the filter to be dried. Alternatively or additionally, the pressure control device is adapted in particular to cancel drying if the pressure of the compressed air fulfils a cancellation condition selected from the group consisting of falling below the first predetermined pressure limit value, exceeding the second predetermined pressure limit value and deviating from the target pressure.

In a preferred embodiment, the pressure control device has a pressure vessel, in particular a buffer tube. Alternatively or additionally, the pressure control device preferably has a pressure reducer, wherein the pressure reducer is adapted to adjust, in particular to control or regulate, a pressure of the compressed air directed through the filter-drying device. Alternatively or additionally, the pressure control device preferably has a pressure reducer, wherein the pressure reducer is adapted to determine and—in particular digitally—indicate a pressure of the compressed air.

According to a further development of the invention, it is provided that the filter-drying device has at least one valve. The at least one valve is at once fluidically connected to the compressed-air connector and the at least one filter connector. The at least one valve is adapted to switch between the first functional state and the second functional state.

Advantageously, the filter connected to the at least one filter connector can be applied with compressed air in a simple manner by means of the at least one valve. Furthermore, it is possible by means of the at least one valve to start and terminate a discharge of the compressed air from the at least one filter connector.

According to a further development of the invention, it is provided that the at least one valve is adapted to be actuated mechanically, hydraulically, pneumatically or electrically.

In a particularly preferred embodiment, the filter-drying device is adapted to divide the compressed air introduced by means of the compressed-air connector such that a first part of the compressed air is directed to the at least one filter connector and that a second part of the compressed air is used as control air for actuating the at least one valve, which in particular can be actuated pneumatically. In particular, it is thus possible to use the compressed air advantageously for drying filters and for actuating the at least one valve. Alternatively or additionally, the pressure control device preferably has a first pressure reducer for the first part of the compressed air, in particular for the compressed air for drying the filters, and a second pressure reducer for the second part of the compressed air, in particular for the compressed air for controlling the at least one valve, wherein the first pressure reducer and the second pressure reducer are adapted to adjust, in particular to control or regulate, the pressure of the compressed air.

According to a further development of the invention, it is provided that the filter-drying device has at least one operating device which is adapted to start the filter-drying. Additionally, the filter-drying device preferably has a signal output which is adapted to indicate a progress of the filter-drying.

Advantageously, it is thus possible to operate the filter-drying device in a simple manner, in particular to start the filter-drying.

Preferably, the operating device is configured such that, when the operating device is actuated, compressed air is directed through the at least one filter connector and thus the filter connected to the at least one filter connector is applied with the compressed air. Particularly preferably, the operating device is operatively connected to the at least one valve and configured such that when the operating device is actuated, the at least one valve is opened, whereby compressed air is directed through the at least one filter connector and thus the filter connected to the at least one filter connector is applied with the compressed air.

In particular, the signal output is adapted to visually indicate the progress of the filter-drying. Alternatively or additionally, the signal output is adapted in particular to acoustically indicate the progress of filter-drying.

In a particularly preferred embodiment, the operating device has at least one operating element, in particular a button. Additionally, the signal output preferably has at least one LED device, which in particular highlights the at least one operating element in colour, in particular with changing colours.

According to a further development of the invention, it is provided that the at least one filter connector is prepared by means of a 3D printing process.

Advantageously, it is thus possible to prepare the at least one filter connector quickly, inexpensively and adapted to the filter to be dried.

According to a further development of the invention, it is provided that the at least one filter connector is adapted to be operated toolless.

Advantageously, a filter can thus be easily and quickly connected to the filter-drying device, in particular to the at least one filter connector.

According to a further development of the invention, it is provided that the filter-drying device has at least two filter connectors. The at least two filter connectors are fluidically connected to the compressed-air connector such that a first filter connector and a second filter connector of the at least two filter connectors can be applied with compressed air independently of each other.

In a particularly preferred embodiment, as the at least one valve a first valve is assigned to the first filter connector a second valve is assigned to the second filter connector. Preferably, the compressed air supply to the first filter connector is controlled by means of the first valve and the compressed air supply to the second filter connector is controlled by means of the second valve. Alternatively or additionally, the first filter connector and the second filter connector are fluidically connected to the compressed-air connector via the pressure control device, in particular via the pressure vessel or the buffer tube. Alternatively or additionally, a first operating element of the operating device is preferably assigned to the first filter connector and thus in particular to the first valve, and preferably a second operating element of the operating device is assigned to the second filter connector and thus in particular to the second valve.

In a further preferred embodiment, the filter-drying device can be operated in a plurality of first functional states. The various first functional states differ in particular in the number of filter connectors that are fluidically connected to the compressed-air connector. In particular, the compressed-air connector can be fluidically connected to exactly one filter connector or to a plurality of filter connectors. In particular, the compressed-air connector is fluidically separated from all filter connectors to which it is not explicitly connected in the manner described. Alternatively or additionally, the filter-drying device is adapted to switch between at least two of the first functional states.

According to a further development of the invention, it is provided that the filter-drying device has a holding device which is adapted to mechanically connect the filter-drying device to at least one device, in particular a media providing filter test device or a multiplier device.

Advantageously, it is thus possible to dry the filters after a test by means of the media providing filter test device and/or a multiplier device quickly and without additionally transporting them to a drying device, in particular the filter-drying device.

According to a further development of the invention, it is provided that the filter-drying device has a drip tray which is vertically arranged at a distance from the at least one filter connector. The drip tray and the at least one filter connector preferably have a vertical distance of at least 17.5 cm. Alternatively, the distance between the filter connector and the drip tray is configured such that the distance is greater than the filter to be dried assigned to the filter connector. In particular, a first end of the filter to be dried is connected to the filter connector and a second end of the filter opposite the first end is at a distance from the drip tray of at least 15 mm when the filter is connected to the filter connector. Alternatively or additionally, the distance between the filter connector and the drip tray is configured such that, on the one hand, preferably all moisture escaping from the filter connected to the filter connector can be collected by means of the drip tray and, on the other hand, preferably the filter can be connected to the filter connector or disconnected from the filter connector in a simple manner.

Advantageously, the drip tray can be used to collect residual liquid that exits from the filters during drying, in particular that is blown out.

Preferably, the drip tray can be removed from the filter-drying device toolless. This makes it advantageously possible to easily and safely empty the residual liquid that has exited, in particular that has been blown, out from the filter and collected in the drip tray.

Particularly preferably, the drip tray has a splash protection sieve, which is inserted loosely. Advantageously, the splash protection sieve prevents a swirling up of the residual liquid collected by the drip tray.

In a particularly preferred embodiment, the filter-drying device has a control device and/or an energy supply line. In particular, the control device is adapted to control the at least one valve, in particular the plurality of valves. Alternatively or additionally, the control device is adapted to receive and process signals from the operating device and/or to control the signal output.

The problem is also solved by creating a process for filter-drying by means of a filter-drying device according to the invention or a filter-drying device according to one or more of the embodiments described above. Thereby, a first opening of a filter is connected to the at least one filter connector, in particular in an airtight manner. Then, in particular sterile compressed air is directed from the compressed-air connector via the filter connector through the filter. The compressed air exits from a second opening of the filter into a surrounding of the filter-drying device, wherein the second opening is preferably not connected to the filter-drying device. In the context with the process in particular the advantages arise, which were already explained in the context with the filter-drying device.

Advantageously, it is possible to dry a plurality of filters independently of each other with a filter-drying device having a plurality of filter connectors.

According to a further development of the invention, it is provided that during filter-drying a pressure above the first predetermined pressure limit value, in particular 1.2 bar, and/or below the second predetermined pressure limit value, in particular 1.8 bar, is set for the in particular sterile compressed air, wherein preferably the filter is applied with the set pressure.

In one embodiment, the pressure of the sterile compressed air is preferably set to a target pressure of preferably 1.2 bar to 1.8 bar, in particular 1.6 bar.

According to a further development of the invention, it is provided that the in particular sterile compressed air is directed through the filter connected to the filter connector for a predetermined period of time, wherein the process is automatically terminated after the predetermined period of time.

In particular, the predetermined period of time is at least 10 minutes to at most 20 minutes, particularly preferably 15 minutes. In particular, the predetermined period of time is matched to at least one property of the filter to be dried, in particular selected from the group consisting of a flow property, a drying property and a permissible residual moisture.

Particularly preferably, the predetermined period of time is selected such that the filter-drying can be carried out faster than a process for filter testing, in particular by means of a media providing filter test device and preferably a multiplier device from PALL, in particular by means of an AquaWIT device and a MUX device from PALL.

According to a further development of the invention, it is provided that by means of the signal output at least one state selected from the group consisting of: filter-drying device is ready for filter-drying, filter-drying is being carried out, filter-drying has been successfully finished, and filter-drying has been cancelled, is indicated.

According to a further development of the invention, it is provided that the pressure of the in particular sterile compressed air is monitored by means of the pressure control device during the filter-drying, wherein preferably the filter-drying is cancelled if the pressure is higher than a first predetermined pressure limit value or lower than a second predetermined pressure limit value.

Advantageously, insufficient drying obtained at a pressure lower than the second predetermined pressure limit value can thus be terminated. Additionally, a drying process in which the filter could be irreversibly damaged due to a pressure which is higher than the first predetermined pressure limit value can advantageously be terminated.

Preferably, the first predetermined pressure limit value and the second predetermined pressure limit value are different from each other. In particular, the second predetermined pressure limit value is lower than the first predetermined pressure limit value. In particular, the first predetermined pressure limit value is preferably 1.8 bar. Alternatively or additionally, the second predetermined pressure limit value is preferably 1.2 bar. Alternatively, the first predetermined pressure limit value and the second predetermined pressure limit value are preferably identical and are preferably 1.6 bar.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The invention is explained in more detail below with reference to the drawings. Thereby it is shown in:

FIG. 1 a schematic representation of an embodiment example of a filter-drying device in a frontal view,

FIG. 2 a schematic representation of the embodiment example of the filter-drying device in a rear view,

FIG. 3 a schematic representation of the embodiment example of the filter-drying device in a first detailed view,

FIG. 4 a schematic representation of the embodiment example of the filter-drying device in a second detailed view,

FIG. 5 a flow diagram of an embodiment example of a process for filter-drying using the embodiment example of the filter-drying device.

### DETAILED DESCRIPTION

Example embodiments will now be described more fully with reference to the accompanying drawings.

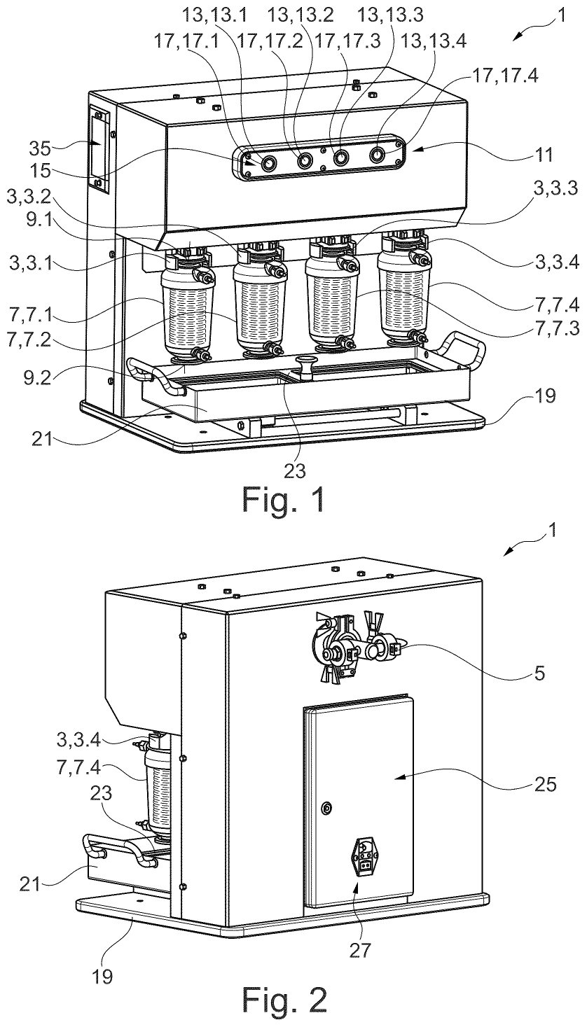

FIG. 1 shows a schematic representation of an embodiment example of a filter-drying device 1 in a frontal view.

The filter-drying device 1 has at least one filter connector 3, in particular a first filter connector 3.1, a second filter connector 3.2, a third filter connector 3.3 and a fourth filter connector 3.4. Furthermore, the filter-drying device 1 has a compressed-air connector 5, which is not visible in this figure. In particular, the compressed-air connector 5 can be seen in FIG. 2. The at least one filter connector 3 is, in particular the first filter connector 3.1, the second filter connector 3.2, the third filter connector 3.3 and the fourth filter connector 3.4, fluidically connected to the compressed-air connector 5 in a first functional state. Additionally, the filter-drying device is adapted to fluidically connect the compressed-air connector 5 to the at least one filter connector 3 in a first functional state and to fluidically separate it from the at least one filter connector 3 in a second functional state.

In particular, in the first functional state, at least one filter connector 3, selected from the first filter connector 3.1, the second filter connector 3.2, the third filter connector 3.3 and the fourth filter connector 3.4, is fluidically connected to the compressed-air connector 5. Additionally, all filter connectors 3 that are not expressly connected to the compressed-air connector 5 in the manner described are fluidically separated from the compressed-air connector 5.

In particular, in the second functional state, all filter connectors 3 are fluidically separated from the compressed-air connector 5.

Additionally, the at least one filter connector 3, in particular the first filter connector 3.1, the second filter connector 3.2, the third filter connector 3.3 and the fourth filter connector 3.4, is adapted to receive a filter 7, in particular a first filter 7.1, a second filter 7.2, a third filter 7.3 and a fourth filter 7.4, and to form an airtight connection between the filter-drying device 1 and the at least one filter 7.

In particular, a first opening 9.1 of the at least one filter 7 can be connected to the at least one filter connector 3 of the filter-drying device 1, in particular airtight. Furthermore, in particular a second opening 9.2 of the at least one filter 7 is preferably not connected to the filter-drying device 1. For a clearer representation, only the first opening 9.1 and the second opening 9.2 of the first filter 7.1 are provided with a reference sign.

The at least one filter 7 is preferably a multi-usable hydrophobic media filter for compressed air and vapour, in particular a multi-usable ventilating filter. Particularly preferably, the at least one filter 7 is a filter of the manufacturer PALL, in particular a filter of the type NOVASIP C3PFRPIA in the embodiment obtainable on the day identifying the seniority of the present intellectual property right.

Particularly preferably, the at least one filter connector 3, in particular the first filter connector 3.1, the second filter connector 3.2, the third filter connector 3.3 and the fourth filter connector 3.4, is adapted to receive a filter 7 having a connector, in particular a TC connector, in accordance with DIN 32676:2009-05 in the version obtainable on the day identifying the seniority of the present intellectual property right and to form an airtight connection between the filter-drying device 1 and such a filter 7.

Preferably, the filter-drying device 1 has at least one operating device 11 adapted to start filter-drying. Particularly preferably, the operating device 11 has at least one operating element 13, in particular a first operating element 13.1, a second operating element 13.2, a third operating element 13.3 and a fourth operating element 13.4. In particular, the at least one operating element 13 is configured as a button. Preferably, the operating device 11, in particular the at least one operating element 13, is configured such that when the operating device 11, in particular the at least one operating element 13, is actuated, compressed air is directed through the at least one filter connector 3 and thus the filter 7 connected to the at least one filter connector 3 is applied with compressed air.

In particular, the first operating element 13.1 is assigned to the first filter connector 3.1 and thus to the first filter 7.1, so that when the first operating element 13.1 is actuated, the drying process of the first filter 7.1 is started. Alternatively or additionally, in particular the second operating element 13.2 is assigned to the second filter connector 3.2 and thus to the second filter 7.2, so that the drying process of the second filter 7.2 is started when the second operating element 13.2 is actuated. Alternatively or additionally, in particular the third operating element 13.3 is assigned to the third filter connector 3.3 and thus to the third filter 7.3, so that the drying process of the third filter 7.3 is started when the third operating element 13.3 is actuated. Alternatively or additionally, in particular the fourth operating element 13.4 is assigned to the fourth filter connector 3.4 and thus to the fourth filter 7.4, so that the drying process of the fourth filter 7.4 is started when the fourth operating element 13.4 is actuated.

Preferably, the filter-drying device 1 has a signal output 15 which is adapted to indicate a progress of the filter-drying. Particularly preferably, the signal output 15 has at least one LED device 17, in particular a first LED device 17.1, a second LED device 17.2, a third LED device 17.3 and a fourth LED device 17.4. In particular, the first LED device 17.1 is assigned to the first operating element 13.1, so that the first LED device 17.1 indicates the progress of the drying process of the first filter 7.1, for example by changing colour or flashing signals or continuous lights. Alternatively or additionally, the second LED device 17.2 is assigned to the second operating element 13.2, so that the second LED device 17.2 indicates the progress of the drying process of the second filter 7.2. Alternatively or additionally, in particular the third LED device 17.3 is assigned to the third operating element 13.3, so that the third LED device 17.3 indicates the progress of the drying process of the third filter 7.3. Alternatively or additionally, in particular the fourth LED device 17.4 is assigned to the fourth operating element 13.4, so that the fourth LED device 17.4 indicates the progress of the drying process of the fourth filter 7.4.

Preferably, the filter-drying device 1 has a holding device 19 which is adapted to connect the filter-drying device 1 to at least one device, in particular a multiplier device.

Particularly preferably, the filter-drying device 1 has a drip tray 21 which is vertically arranged at a distance from the at least one filter connector 3. The drip tray 21 and the at least one filter connector 3 preferably have a vertical distance of at least 17.5 cm. In particular, the drip tray 21 can be removed from the filter-drying device 1 toolless. Additionally, the drip tray 21 preferably has a splash protection sieve 23, which in particular is inserted loosely into the drip tray 21. Advantageously, the splash protection sieve 23 prevents a swirling up of the residual liquid collected by the drip tray 21.

In addition, the filter-drying device 1 has, in particular, a indication device 35 adapted to indicate a pressure of the compressed air introduced via the compressed-air connector 5.

In particular, the filter-drying device 1 is adapted to carry out a process for drying the at least one filter 7 according to FIG. 5.

FIG. 2 shows a schematic representation of the embodiment example of the filter-drying device 1 in a rear view.

Identical and functionally identical elements are provided with the same reference signs in all figures, so that reference is made to the previous description in each case.

Particularly preferably, the compressed-air connector 5 is configured as a connector for sterile compressed air, in particular as a sterile air connector.

Preferably, the filter-drying device 1 is adapted to divide the compressed air introduced by means of the compressed-air connector 5 such that a first part of the compressed air is directed to the at least one filter connector 3 and that a second part of the compressed air is used as control air for actuating at least one valve 29—which is shown in particular in FIG. 4. In particular, it is thus possible to use the compressed air advantageously to dry the filters 7 and to control the filter-drying device 1, in particular to start or terminate the filter-drying.

In particular, the filter-drying device 1 has a control device 25 and/or an energy supply line 27, wherein the control device 25 is preferably adapted to receive and process signals from the operating device 11 and/or to control the signal output 15.

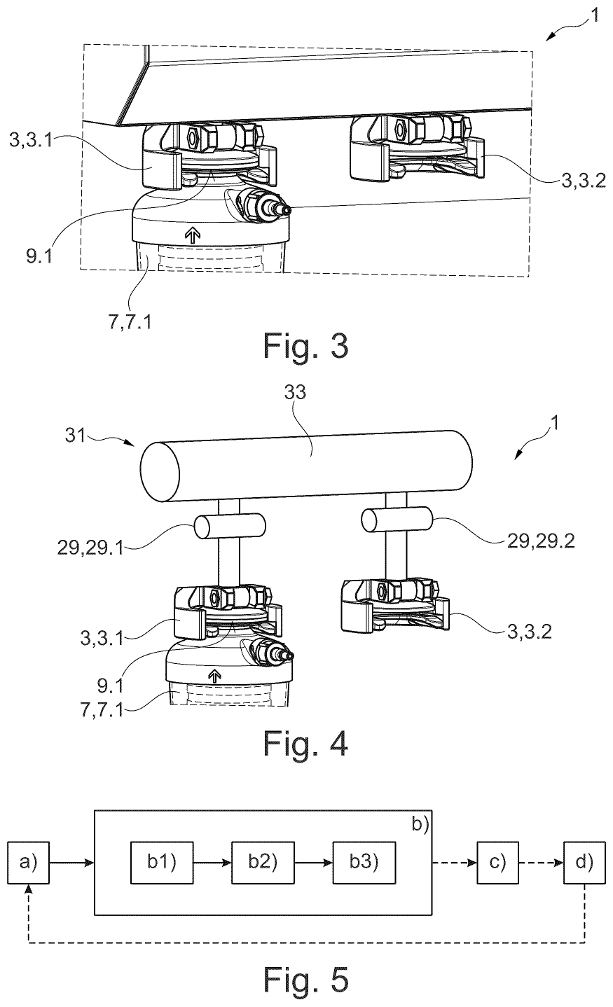

FIG. 3 shows a schematic representation of the embodiment example of the filter-drying device 1 in a first detailed view.

The first detailed view shows two filter connectors 3, in particular the first filter connector 3.1 and the second filter connector 3.2, wherein the first filter connector 3.1 is connected to the first filter 7.1 and the second filter connector 3.2 is not connected to any filter 7.

Preferably, the at least one filter connector 3, in particular the plurality of filter connectors 3, is prepared by means of a 3D printing process. It is particularly preferred that the at least one filter connector 3 is adapted to be operated toolless. In particular, the at least one filter connector 3 is adapted to connect the filter 7 to the at least one filter connector 3 toolless.

FIG. 4 shows a schematic representation of the embodiment example of the filter-drying device 1 in a second detailed view.

The second detailed view shows an identical section of the filter-drying device 1 as the first detailed view in FIG. 3. However, the covering of the filter-drying device 1 is hidden in FIG. 4.

Preferably, the at least one filter connector 3 is fluidically connected to the compressed-air connector 5 via the at least one valve 29 in the first functional state and fluidically separated from the compressed-air connector 5 in the second functional state, wherein the at least one valve 29 is particularly preferably mechanically, hydraulically, pneumatically or electrically actuated. In particular, the first filter connector 3.1 is fluidically connected to the compressed-air connector 5 by means of a first valve 29.1. Alternatively or additionally, in particular the second filter connector 3.2 is fluidically connected to the compressed-air connector 5 by means of a second valve 29.2.

Particularly preferably, the compressed air supply to the first filter connector 3.1 is controlled by means of the first valve 29.1 and the compressed air supply to the second filter connector 3.2 is controlled by means of the second valve 29.2. Alternatively or additionally, the first operating element 13.1 of the operating device 11 is preferably assigned to the first filter connector 3.1 and thus in particular to the first valve 29.1, and preferably the second operating element 13.2 of the operating device 11 is assigned to the second filter connector 3.2 and thus in particular to the second valve 29.2. Alternatively or additionally, the control device 25 is preferably adapted to control the at least one valve 29, in particular the first valve 29.1 and the second valve 29.2, depending on an input via the respective control element 13.

Preferably, the filter-drying device 1 has a pressure control device 31. The pressure control device 31 is fluidically connected to the compressed-air connector 5 and the at least one filter connector 3, in particular the first filter connector 3.1 and the second filter connector 3.2, and is fluidically arranged between the compressed-air connector 5 and the at least one filter connector 3. In particular, the pressure control device 31 is adapted to adjust, in particular to control or regulate, the pressure of the compressed air above a first predetermined pressure limit value, wherein the first predetermined pressure limit value is preferably 1.2 bar. Alternatively or additionally, the pressure control device 31 is in particular adapted to adjust, in particular to control or regulate, the pressure of the compressed air below a second predetermined pressure limit value, wherein the second predetermined pressure limit value is preferably 1.8 bar. Alternatively or additionally, the pressure control device 31 is in particular adapted to adjust, in particular to control or regulate, the pressure of the compressed air to a target pressure, wherein the target pressure is preferably from 1.2 bar to 1.8 bar, preferably 1.6 bar, and/or wherein the target pressure is matched to the filter 7 to be dried. Alternatively or additionally, the pressure control device 31 is adapted in particular to cancel drying if the pressure of the compressed air fulfils a cancellation condition selected from the group consisting of falling below the first predetermined pressure limit value, exceeding the second predetermined pressure limit value and deviating from the target pressure.

Particularly preferably, the pressure control device 31 has a pressure accumulator 33 configured in particular as a buffer tube. Alternatively or additionally, the pressure control device 31 is adapted to determine a pressure of the compressed air and in particular to indicate, in particular digitally, in particular by means of the indication device 35 shown in FIG. 1.

Furthermore, the first filter connector 3.1 and the second filter connector 3.2 are particularly preferably fluidically connected to the compressed-air connector 5 via the pressure control device 31, in particular via the buffer tube 33.

FIG. 5 shows a flow diagram of an embodiment example of a process for filter-drying by means of the embodiment example of the filter-drying device 1.

In a first step a), the first opening 9.1 of the filter 7 is connected to the at least one filter connector 3 of the filter-drying device 1, in particular airtight. Preferably, the filter 7 is connected to the filter-drying device 1 such that the second opening 9.2 is not connected to the filter-drying device 1. In particular, the filter 7 is connected to the filter-drying device 1 against a flow direction of the filter 7.

In a second step b), in particular sterile compressed air is directed from the compressed-air connector 5 via the filter connector 3 through the filter 7, wherein the compressed air exits from the second opening 9.2 of the filter 7 into a surrounding of the filter-drying device 1. Preferably, the in particular sterile compressed air is directed through the filter 7 connected to the filter connector 3 for a predetermined period of time, wherein the drying process is automatically terminated after the predetermined period of time.

Preferably, in a first second step b1), the operating device 11, in particular the operating element 13 assigned to the filter connector 3, is actuated. Then, preferably in a second second step b2), the valve 29 assigned to the filter connector 3 is opened so that compressed air can flow through the filter 7. Particularly preferably, in the second second step b2), the filter 7 is applied with in particular sterile compressed air at a pressure of at least 1.2 bar to at most 1.8 bar, particularly preferably 1.6 bar, wherein this pressure is set in the filter-drying device 1. In a third second step b3), the valve 29 assigned to the filter connector 3 is closed, in particular automatically, so that compressed air can no longer flow through the filter 7 and thus the drying process is completed. In particular, the second second step b2) is carried out for a predetermined period of time, particularly preferably 15 minutes. Alternatively or additionally, in particular during the second second step b2), the pressure of the in particular sterile compressed air is monitored by means of the pressure control device 31, wherein preferably the second second step b2) is cancelled and the third second step b3) is started if the pressure is higher than a first predetermined pressure limit value or lower than a second predetermined pressure limit value.

In particular, a state that the filter-drying is being carried out is preferably indicated in the second second step b2) by means of the signal output 15. Alternatively or additionally, in the third second step b3), a state that the filter-drying has been successfully completed or that the filter-drying has been cancelled is indicated by means of the signal output 15.

In an optional third step c), the filter 7 is withdrawn from the filter-drying device 1.

In an optional fourth step d), a state that the filter-drying device 1 is ready for filter-drying is indicated by means of the signal output 15. In particular, the first step a) can be carried out again after the optional fourth step d) or when the filter 7 to be dried has been withdrawn from the filter-drying device 1.

In particular, the filter 7 can be connected to the filter-drying device 1 and removed again in the first step a) and the third step c) toolless.

The foregoing description of the embodiment has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A filter-drying device for filter-drying, the filter-drying device having a compressed-air connector and at least one filter connector, wherein the filter-drying device is adapted to fluidically connect the compressed-air connector to the at least one filter connector in a first functional state and to fluidically separate the compressed-air connector from the at least one filter connector in a second functional state, wherein the at least one filter connector is adapted to receive a filter and to form an airtight connection between the filter-drying device and the filter, and wherein the filter-drying device has a pressure control device for monitoring the pressure of the compressed air during the filter-drying, and wherein the pressure control device is adapted to cancel the filter-drying if the pressure is higher than a first predetermined pressure limit value or lower than a second predetermined pressure limit value.

2. The filter-drying device of claim 1, wherein the pressure control device is fluidically connected to the compressed-air connector and the filter connector and is fluidically arranged between the compressed-air connector and the filter connector.

3. The filter-drying device of claim 1, having at least one valve, wherein the at least one valve is at once fluidically connected to the compressed-air connector and to the at least one filter connector, wherein the at least one valve is adapted to switch between the first functional state and the second functional state.

4. The filter-drying device of claim 3, wherein the at least one valve is adapted to be actuated mechanically, hydraulically, pneumatically or electrically.

5. The filter-drying device of claim 1, having at least one operating device adapted to start a filter-drying, and preferably a signal output adapted to indicate a progress of the filter-drying.

6. The filter-drying device of claim 1, wherein the at least one filter connector is prepared by means of a 3D printing process.

7. The filter-drying device of claim 1, wherein the at least one filter connector is adapted to be operated toolless.

8. The filter-drying device of claim 1, having at least two filter connectors, wherein the at least two filter connectors are fluidically connected to the compressed-air connector such that a first filter connector and a second filter connector of the at least two filter connectors are appliable with compressed air independently of each other.

9. The filter-drying device of claim 1, having a holding device which is adapted to mechanically connect the filter-drying device to at least one device.

10. The filter-drying device of claim 1, having a drip tray which is vertically arranged at a distance from the at least one filter connector.

11. A process for filter-drying by means of the filter-drying device of claim 1 having a compressed-air connector and at least one filter connector, wherein the filter-drying device is adapted to fluidically connect the compressed-air connector to the at least one filter connector in a first functional state and to fluidically separate the compressed-air connector from the at least one filter connector in a second functional state, wherein the at least one filter connector is adapted to receive a filter and to form an airtight connection between the filter-drying device and the filter, wherein a first opening of the filter is connected airtight to the at least one filter connector, wherein sterile compressed air is directed from the compressed-air connector via the at least one filter connector through the filter and exits from a second opening of the filter into a surrounding of the filter-drying device, wherein the pressure of the compressed air is monitored by means of a pressure control device during the filter-drying, and wherein the filter-drying is cancelled if the pressure is higher than a first predetermined pressure limit value or lower than a second predetermined pressure limit value.

12. The process of claim 11, wherein during the filter-drying a pressure of at least 1.2 bar to at most 1.8 bar is set for the sterile compressed air, wherein the filter is applied with the set pressure.

13. The process of claim 11, wherein the sterile compressed air is directed through the filter connected to the at least one filter connector for a predetermined period of time, wherein the process is automatically terminated after the predetermined period of time.

14. The process of claim 11, wherein by means of a signal output at least one state selected from the group consisting of: filter-drying device is ready for filter-drying, filter-drying is being carried out, filter-drying has been successfully finished, and filter-drying has been cancelled, is indicated.

15. (canceled)

16. The filter drying device of claim 1, wherein the filter is a multi-usable ventilating filter.

17. The filter drying device of claim 9, wherein the at least one device is a media providing filter test device or a multiplier device.

18. The filter drying device of claim 10, wherein the drip tray and the at least one filter connector have a vertical distance of at least 17.5 cm.

19. The process of claim 12, wherein the pressure is approximately 1.6 bar.
